(19) United States
(12) Patent Application Publication
(10) Pub. No.: US 2024/0240762 A1
(43) Pub. Date: Jul. 18, 2024

(54) Cryogenic tank comprising a withdrawal device

(71) Applicant: MAGNA Energy Storage Systems GesmbH, Sinabelkirchen (AT)

(72) Inventors: Stefan MOLDENHAUER, Ilmenau (DE); Sergiy PUTSELYK, Pinkafeld (AT)

(73) Assignee: MAGNA Energy Storage Systems GesmbH, Sinabelkirchen (AT)

(21) Appl. No.: 18/411,377

(22) Filed: Jan. 12, 2024

(30) Foreign Application Priority Data
Jan. 13, 2023 (DE) 102023200257.4

(51) Int. Cl. F17C 9/02

(52) U.S. Cl. CPC F17C 9/02; F17C 2203/0391; F17C 2203/0629; F17C 2205/0358; F17C 2221/012; F17C 2223/0161; F17C 2227/0306

(57) ABSTRACT

A cryotank that includes an inner tank for receiving a medium stored in the cryotank; an outer container enclosing the inner tank; an insulation space arranged between the inner tank and the outer container; a first heat exchanger arranged outside the inner tank and the outer container; an extraction device for the medium, the extraction device having at least one extraction line arranged in the insulation space to facilitate conveying of the medium out of the inner tank to the first heat exchanger; and a recirculation line back arranged in the insulation space in thermal contact with the at least one extraction line to facilitate conveying a recirculation partial flow back into the inner tank and an extraction partial flow downstream of the first heat exchanger to a consumer.

### CROSS-REFERENCE TO RELATED APPLICATIONS

The present application claims priority under 35 U.S.C. § 119 to German Patent Publication No. 10 2023 200 257.4 (filed on Jan. 13, 2023), which is hereby incorporated by reference in its complete entirety.

### TECHNICAL FIELD

One or more embodiments of the present disclosure relates to a cryotank comprising an extraction device for the medium stored (i.e., hydrogen) in the cryotank.

### BACKGROUND

Cryotanks which comprise an inner tank for receiving a medium (i.e., hydrogen), an outer container enclosing the inner tank, and an insulation space, in particular a vacuum space, between the inner tank and the outer container, are known. Such cryotanks may in particular be used as mobile cryotanks in motor vehicles in order to carry a medium such as hydrogen or LNG as fuel for powering the motor vehicle.

Such cryotanks conventionally comprise an extraction device for the medium (i.e., hydrogen) stored in the cryotank so that the medium is conveyed out of the inner tank via an extraction line to a first heat exchanger arranged outside the inner tank, in order to warm the hydrogen, the warmed hydrogen being supplied to a consumer downstream of the first heat exchanger.

It is also already known that a recirculation partial flow may be branched off from the extraction line and conveyed via a recirculation line back into the inner tank, in order to warm the medium in the tank and increase the pressure in the inner tank.

Cryopressure gas (for example hydrogen at 30 K) can in this case be extracted from the cryotank and warmed with the aid of a first heat exchanger. A first partial gas flow is subsequently recycled through a closed pipeline system into an inner-tank heat exchanger in the inner tank of the cryotank. The inner-tank heat exchanger is used to evaporate and therefore extract the cryogas. The recycling of the gas leads to its being cooled, which can be compensated for by a second heat exchanger. The two gas flows are supplied to the consumer after they have been combined. The partial recycling allows a heat supply into the cryotank and therefore a pressure build-up by evaporation of the cryogenic gas.

Such an extraction device requires installation of the heat exchangers in the insulation vacuum of the cryostorage unit, since no components whose temperature is below 90 K must come in contact with air. If this were to be the case, atmospheric oxygen condensation could take place.

Owing to the heat transfer by film boiling in the inner-tank heat exchanger, the recycled partial gas flow is usually cooled only slightly and its enthalpy is therefore changed only to a small extent. Although it allows the second heat exchanger to be made much smaller, this is associated with loading of the first heat exchanger and therefore increases its risk of freezing.

The known solution therefore has at least the following disadvantages. Maintenance or repair of the heat exchangers is made difficult or impossible. There is an increased potential for leaks in the insulation vacuum. Complicated line routing in the vacuum space leads to difficult application of multi-layer insulation (MLI), or an increased parasitic heat input into the tank. There is a risk of the heat exchangers freezing in the insulation vacuum, in particular for the first heat exchanger because it is usually exposed to cold cryogas at 30 K. It is necessary to use two very different heat exchangers. The inner tank is reduced in size because space is required for the heat exchangers and pipelines in the insulation vacuum.

FIG. 1 shows a related art cryotank having an extraction device. The cryotank comprises an inner tank 101 for receiving a medium (i.e., hydrogen), an outer container 102 enclosing the inner tank 101, and an insulation space 103, namely, a vacuum space, between the inner tank 101 and the outer container 102. During normal operation of the cryotank, there is liquid hydrogen in the inner tank 101 in the lower region, in the vicinity of the bottom of the inner tank 101 (indicated by dashes) and gaseous hydrogen above the latter.

### SUMMARY

The one or more embodiments of the present disclosure provides a cryotank comprising an extraction device for the medium (i.e., hydrogen) stored in the cryotank which does not have at least a number of the aforementioned disadvantages. In particular, a cryotank which allows a larger inner tank and simpler maintenance of the heat exchangers is intended to be provided.

In accordance with one or more embodiments, a cryotank comprises an inner tank for receiving a medium (i.e., hydrogen) stored in the cryotank; an outer container enclosing the inner tank; an insulation space arranged between the inner tank and the outer container; and an extraction device for the medium stored in the cryotank, the extraction device having at least one extraction line through which the medium is conveyed out of the inner tank to a first heat exchanger arranged outside the inner tank and the outer container, wherein an extraction partial flow of the medium is conveyed downstream of the first heat exchanger to a consumer and a recirculation partial flow is conveyed via a recirculation line back into the inner tank, wherein the extraction line and the recirculation line are configured in the insulation space to establish thermal contact between the extraction line and the recirculation line.

In accordance with one or more embodiments, a cryotank has an extraction device for extracting the medium stored in the inner tank in order to supply the medium to a consumer. A partial flow may be branched off from the extraction line and conveyed in a recirculation line back into the inner tank, so that the partial flow hitherto warmed can warm the medium in the inner tank.

In accordance with one or more embodiments, the cryotank is produced so that the heat exchanger, or optionally even a plurality of heat exchangers, in particular two heat exchangers, which are used to warm the extracted medium, are arranged in the air space outside the outer container and therefore outside the insulation space. This is technically expediently possible when the temperatures occurring at the heat exchangers are above the liquefaction temperature of oxygen, that is to say greater than 90 K. In order to lie reliably above this temperature, the component temperatures should not in fact fall below 120 K.

The extraction device of the cryotank in accordance with one or more embodiments is therefore configured so that the available enthalpy of the recirculated partial gas flow is utilized much more. The extraction line and the recirculation line are for this purpose configured in the insulation space so that there is a good thermal contact between the extraction line and the recirculation line. The medium in the recirculation line may therefore release heat to the medium in the extraction line.

Preferably, the extraction line and the recirculation line are configured in the insulation space as tubes thermally connected well to one another. The tube which forms the extraction line and the tube which forms the recirculation line may be arranged in physical contact with one another. Preferentially, however, the extraction line and the recirculation line have a tube wall section common to the extraction line and the recirculation line at least in sections along their extent through the insulation space and at least along a sector of their circumference. The extraction line and the recirculation line therefore preferentially share at least a part of a tube wall.

Preferentially, the extraction line and the recirculation line are configured in the insulation space as tubes thermally connected well to one another, by the extraction line and the recirculation line forming coaxial tubes at least in sections along their extent through the insulation space. One of the two tubes therefore extends coaxially outside the other tube. Preferably, the extraction line is routed on the outside and the recirculation line is routed on the inside.

In accordance with one or more embodiments, the recirculation partial flow is delivered via a blower via the recirculation line back into the inner tank, and opens into the inner tank preferably in the vicinity of the bottom where there is usually liquid medium in the inner tank during operation, so that the liquid cryogenic medium is warmed and evaporated.

Preferably, the recirculation partial flow, which is conveyed via the recirculation line back into the inner tank, is conveyed in the inner tank through an inner-tank heat exchanger and is conveyed downstream of the inner-tank heat exchanger via a secondary recirculation line section of the recirculation line to a second heat exchanger arranged outside the inner tank. The recirculated medium therefore releases its heat via an inner-tank heat exchanger which is preferably arranged in the vicinity of the bottom of the inner tank, and releases the heat to liquid medium during normal operation, and then flows further, back out of the inner tank, via a secondary recirculation line section of the recirculation line.

The re-emerging partial flow of the medium is warmed again in a second heat exchanger and may then be supplied to a consumer.

The second heat exchanger is preferentially likewise arranged outside the outer container.

The extraction line and the secondary recirculation line section of the recirculation line are preferentially configured in the insulation space so that there is a good thermal contact between the extraction line and the secondary recirculation line section of the recirculation line. Heat transfer may therefore take place both from the “primary” part of the recirculation line, and from the secondary recirculation line section of the recirculation line, towards the extraction line.

The extraction line and the recirculation line and the secondary recirculation line section of the recirculation line are preferentially formed in the insulation space as tubes thermally connected well to one another, particularly preferentially by the extraction line and the recirculation line and the secondary recirculation line section of the recirculation line sharing at least a part of a tube wall respectively with one another, or all three tubes together, and preferably all three tubes forming coaxial tubes in the insulation space, at least in sections along their extent through the insulation space.

The extraction line is then preferentially the central tube embedded between the recirculation line and the secondary recirculation line section of the recirculation line. The recirculation line is particularly preferentially the radially inner-lying central tube.

The lines, in particular tubes, thermally connected well to one another, i.e. the tube arrangement including two and preferentially three tubes, are preferably arranged at least partially, around preferentially mostly, in an elongate installation space which extends into the inner tank and topologically belongs to the insulation space. A multi-layer insulation (MLI) is preferentially arranged around the tube arrangement.

### DRAWINGS

One or more embodiments of this disclosure will be illustrated by way of example in the drawings and explained in the description hereinbelow.

FIG. 1 is a schematic representation of a related art cryotank.

FIG. 2 is a schematic representation of a cryotank in accordance with one or more embodiments.

FIG. 3 is a schematic representation of a further cryotank in accordance with one or more embodiments.

FIG. 4 is a schematic representation of a tube arrangement in the insulation space of a cryotank in accordance with one or more embodiments, from the side (large image) and in cross section from the front (small image).

FIG. 5 is a schematic representation of a further tube arrangement in the insulation space of a cryotank in accordance with one or more embodiments, from the side (large image) and in cross section from the front (small image).

FIG. 6 is a schematic representation of a tube arrangement in the insulation space of a cryotank in accordance with one or more embodiments.

FIG. 7 is a schematic representation of a further tube arrangement in the insulation space of a cryotank in accordance with one or more embodiments.

FIG. 8 is a schematic representation of a further cryotank in accordance with one or more embodiments.

FIG. 9 is a schematic representation of a further tube arrangement in the insulation space of a cryotank in accordance with one or more embodiments, from the side (large image) and in cross section from the front (small image).

FIG. 10 is a schematic representation of a further tube arrangement in the insulation space of a cryotank in accordance with one or more embodiments, from the side (large image) and in cross section from the front (small image).

### DESCRIPTION

The cryotank comprises an extraction device for the medium (i.e., hydrogen) stored in the cryotank. The extraction device comprises an extraction line 4 to convey the medium out of the inner tank 1 to a first heat exchanger 5 arranged outside the inner tank 1, namely, in the insulation space 3. Downstream of the first heat exchanger 5, an extraction partial flow is conveyed to a consumer 6. A recirculation of a partial flow of the medium back into the inner tank 1 is conveyed via a recirculation line 7, where it can warm the stored medium via an inner-tank heat exchanger 10. The medium contained in the recirculation line 7 is then conveyed via a secondary recirculation line section 11 of the recirculation line 7 back out from the inner tank 1 into the insulation space 3, where it is warmed by a second heat exchanger 12 and conveyed to the consumer 6. In order to branch off a desired partial flow for the recirculation via the recirculation line 7, a valve 13 is arranged in the recirculation line 7 and a throttle 14 is arranged between the branching of the recirculation line 7 from the extraction line 4 and the secondary recirculation line section 11 of the recirculation line 7.

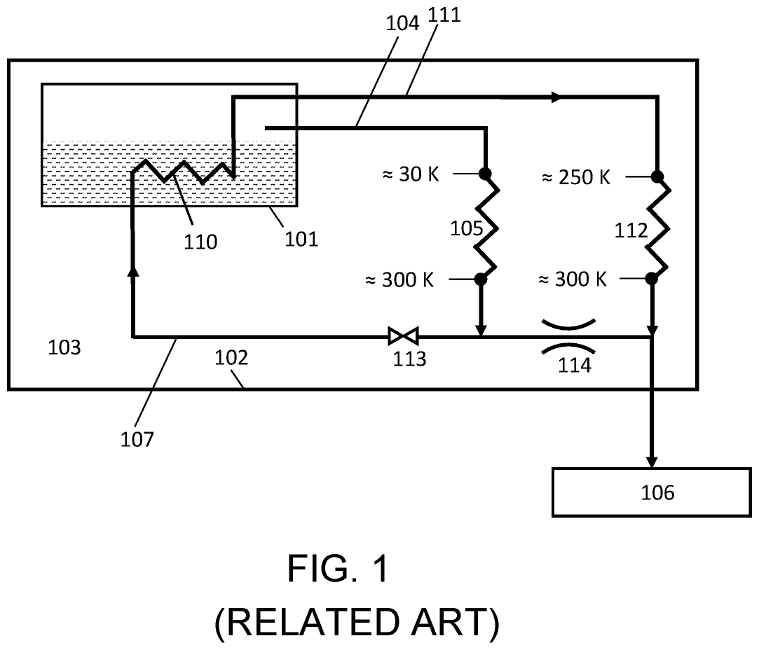

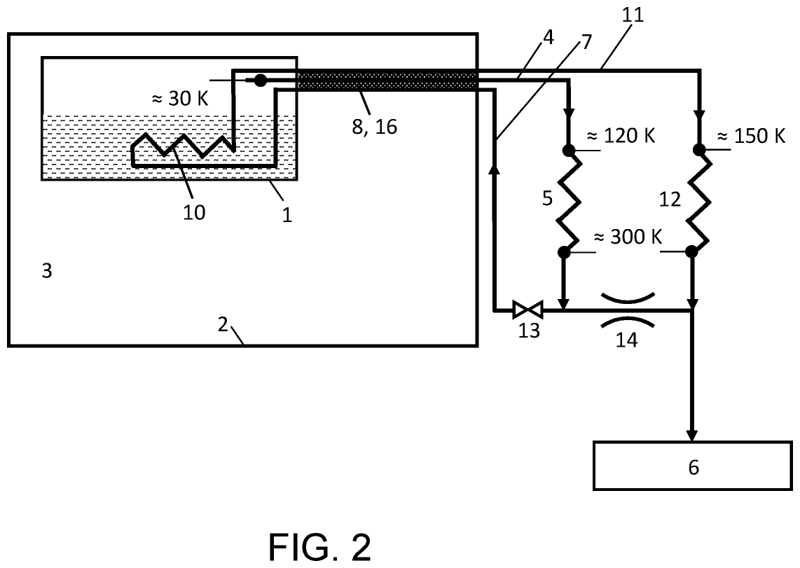

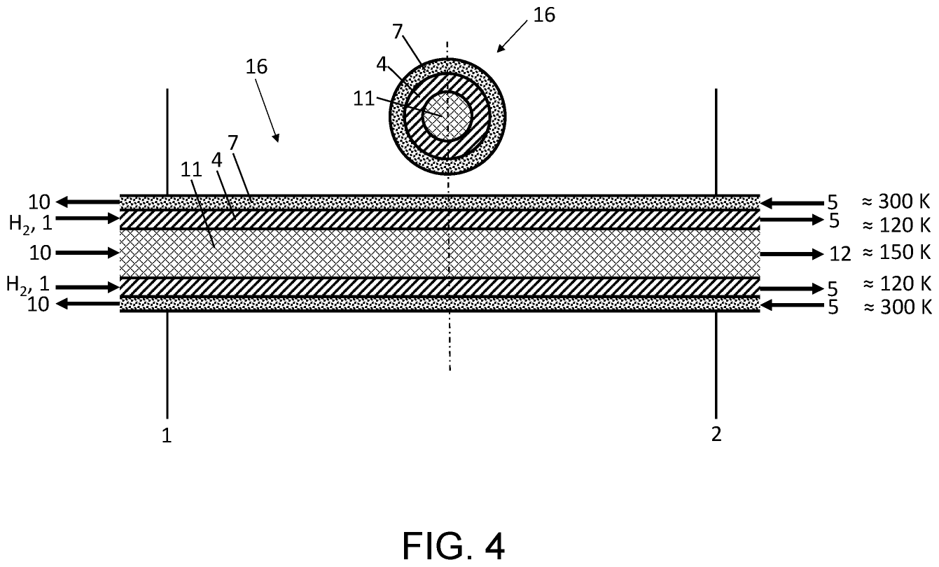

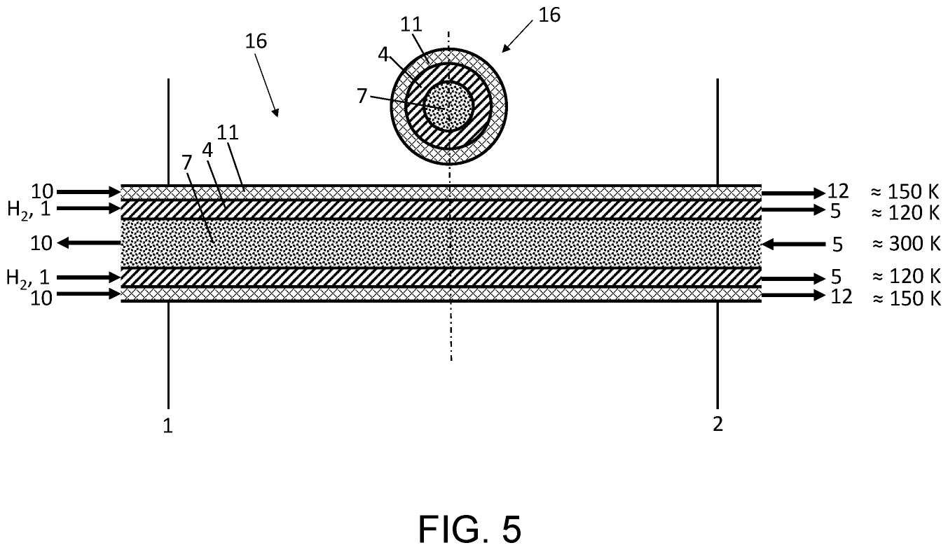

The cryotank in accordance with one or more embodiments of FIG. 2 differs from the related art cryotank of FIG. 1 in that the first heat exchanger 5 and the second heat exchanger 12 are arranged outside of the outer container 2. The extraction line 4, the recirculation line 7, and the secondary recirculation line section 11 of the recirculation line 7 are configured in the insulation space 3 so that there is a good thermal contact 8 between the extraction line 4, recirculation line 7, and secondary recirculation line section 11 of the recirculation line 7. In the insulation space 3, the extraction line 4, the recirculation line 7, and the secondary recirculation line section 11 of the recirculation line 7 constitute a common tube arrangement 16, which is formed by configuring the extraction line 4, the recirculation line 7 and the secondary recirculation line section 11 of the recirculation line 7 as coaxial tubes (see FIGS. 4 and 5).

Cryopressure gas, for example, hydrogen at about 30 K, can be extracted from the cryotank via the extraction line 4 and warmed with the aid of the first heat exchanger 5. A first partial gas flow is subsequently recycled through a closed pipeline system into the inner tank 1 to the inner-tank heat exchanger 10 of the cryotank. The inner-tank heat exchanger 10 is used to evaporate, and therefore, extract the cryogas. In order to allow the recycling, a throttle 14 in the non-recycled second partial gas flow is used. The valve 13 indicated in FIG. 2 is used to shut off the recycled first partial gas flow. The recycling of the gas leads to its being cooled, which can be compensated for by the second heat exchanger 12. The two gas flows are supplied to the consumer 6 after they have been combined. The partial recycling allows a heat supply into the cryotank and therefore a pressure build-up by evaporation of the cryogenic gas.

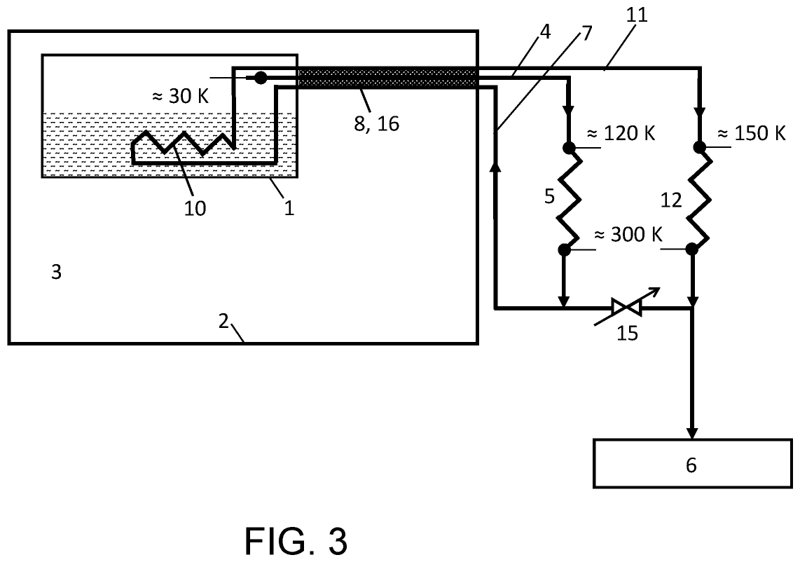

The central component is the tube arrangement denoted by “thermal contact” 8. This can allow firstly heat transfer between the evaporated cryogas at about 30 K and the partial gas flow recirculated from the first heat exchanger 5 to the inner-tank heat exchanger 10, and secondly heat transfer between the evaporated cryogas at about 30 K and the partial gas flow recirculated from the inner-tank heat exchanger 10 to the second heat exchanger 12. Advantageously, the former takes place in counter-current flow and the latter in concurrent flow (see FIGS. 4 and 5). The combination of a valve 13 and throttle 14 may, as represented in FIG. 3, be replaced with a control valve 15 in order to allow continuous regulating of the recirculated partial gas flow.

In a particularly advantageous embodiment of the extraction device in accordance with one or more embodiments, the component denoted by “thermal contact” 8 in FIGS. 2 and 3, i.e. the tube arrangement 16 (see FIGS. 4 and 5), is embodied by a coaxial arrangement of three tubes. FIGS. 4 and 5 represent two possible embodiments in this regard, namely, two different fluid routings in coaxial tube arrangements 16.

It has been found that by the arrangement of FIGS. 2 and 3 with a tube arrangement 16 of FIG. 4, warming of the cryogas flow (hydrogen) extracted at about 30 K to at least 120 K is possible before it reaches the first heat exchanger 5. The recycled partial gas flow entering into the second heat exchanger 12 then only has a temperature of about 150 K. Its enthalpy is therefore utilized much better than in the arrangement of the prior art (cf. the indications of the temperatures in FIG. 1, also in comparison with FIGS. 2 and 3). Installation of two heat exchangers 5 and 12 of equal sizes in the air space, i.e. outside the insulation space 3, is therefore possible without the risk of oxygen condensation.

As an alternative to the fluid routing of FIG. 4, fluid routing of FIG. 5 is possible, in which the evaporated cryogas flow (in the extraction line 4) always needs to be enclosed by the partial gas flow leading to the inner-tank heat exchanger 10 and coming from the inner-tank heat exchanger 10 (radially inwards and radially outwards). The performance of fluid routing of FIG. 4 is superior to that of FIG. 5.

In the extraction device in accordance with one or more embodiments, it is necessary to ensure that a sufficient partial gas flow is constantly recirculated during a cryogas extraction in order to keep the exit temperature of the cryogas emerging from the vacuum region, i.e. the insulation space 3, above the condensation temperature of oxygen by the heat transfer. This needs to be taken into account during extraction at an already elevated inner tank pressure, since in this case cryogas evaporation is not immediately necessary. It does not, however, militate against cryogas recirculation with a mass flow rate lower than would be necessary for an evaporation sufficient for the extraction, in order to keep the exit temperature of the extracted cryogas at least above 90 K. The pressure build-up in the inner tank 1 then proceeds somewhat more slowly than in the case of extraction without recirculation. Furthermore, cryoliquid accumulation in the extraction line 4 may require an increased heat input through the coaxial tube arrangement. For the two reasons mentioned, it is recommended to dimension the coaxial tube arrangement 16 to be larger in terms of heat transfer, and in particular geometrically longer, or long. The tube arrangement 16 may for example extend over at least 40%, preferentially at least 60% or at least 70% of the length of the inner tank 1.

An extraction method for a cryotank may comprise the steps of the cryogas flow extracted from the inner tank 1 being routed via an extraction line 4 and warmed in a first heat exchanger 5, and a partial gas flow branched off therefrom being delivered via a recirculation line 7 back to the inner tank 1, and the partial gas flow conveyed to the inner tank 1 passing through an inner-tank heat exchanger 10, subsequently being delivered via a line 11 to a second heat exchanger 12 and combined with the main flow downstream of a control valve 15 which throttles the main gas flow, the evaporated cryogas flow coming from the inner tank 1 and conveyed to the first heat exchanger 5 being in thermal contact with the partial gas flow supplied to the inner tank 1 and discharged from the latter, and heat transfer taking place between the three fluid flows.

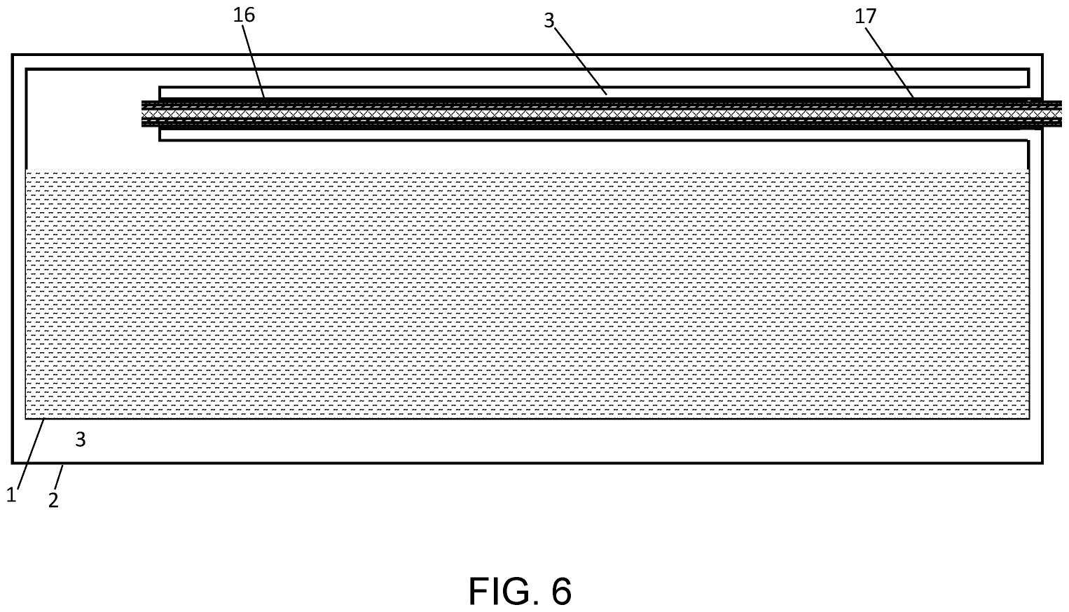

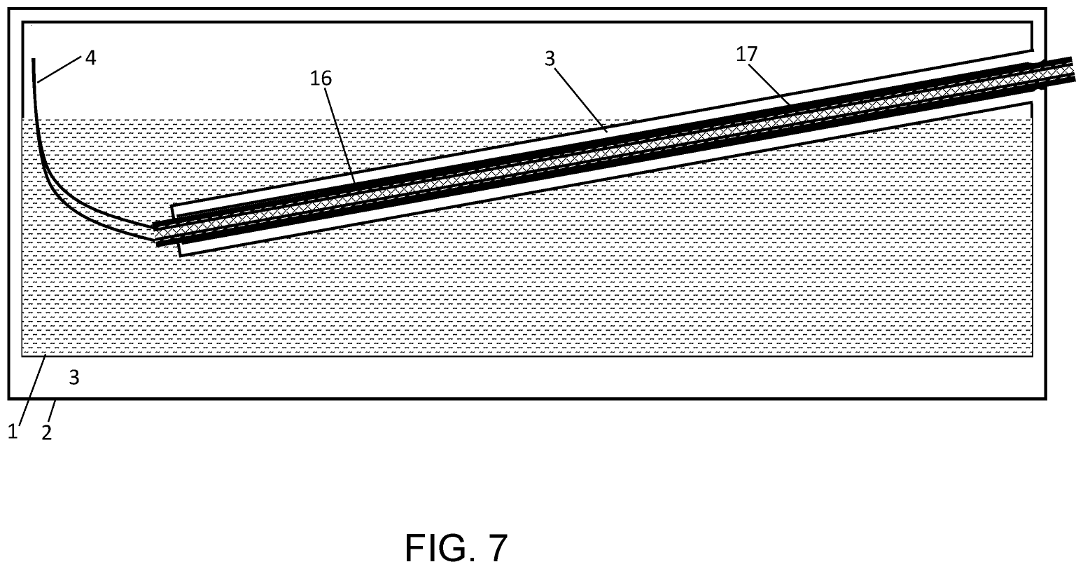

In a further advantageous embodiment of the device in accordance with one or more embodiments, the insulation vacuum, i.e., the insulation space 3, around the coaxial tube arrangement 16, as represented in FIGS. 6 and 7, is incorporated into the installation space of the inner tank 1. This allows a sufficient length of the coaxial tube arrangement 16 for the heat transfer in combination with a multi-layer insulation (MLI) 17 that is easy to install, since it can be applied more easily on a straight tube. The coaxial arrangement of the three tubes furthermore has the advantage over the prior art as represented in FIG. 1 that only one pipeline instead of three needs to be provided with MLI, which reduces the manufacturing outlay. This arrangement is illustrated in FIG. 6, namely a coaxial tube arrangement 16 having an insulation space 3, in particular a vacuum, incorporated into the inner tank 1, and multi-layer insulation 17.

The tube arrangement 16 may extend substantially parallel with respect to the bottom of the inner tank 1 and may preferably be arranged close to the roof, i.e. at the top in the inner tank 1, as represented in FIG. 6. In order to avoid liquid accumulation in the coaxial tube arrangement 16, an oblique setting of the latter is also possible, as represented in FIG. 7. In this case, the end of the extraction line 4 may preferably be placed upwards so that the access to the extraction line 4 is still arranged close to the roof, i.e. at the top in the inner tank 1, and gaseous medium can be extracted through the extraction line 4 during normal operation (cf. FIG. 7). FIG. 7 therefore shows an obliquely positioned coaxial tube arrangement 16 having a vacuum, i.e. insulation space 3, incorporated into the inner tank 1, and MLI 17 around the tube arrangement 16.

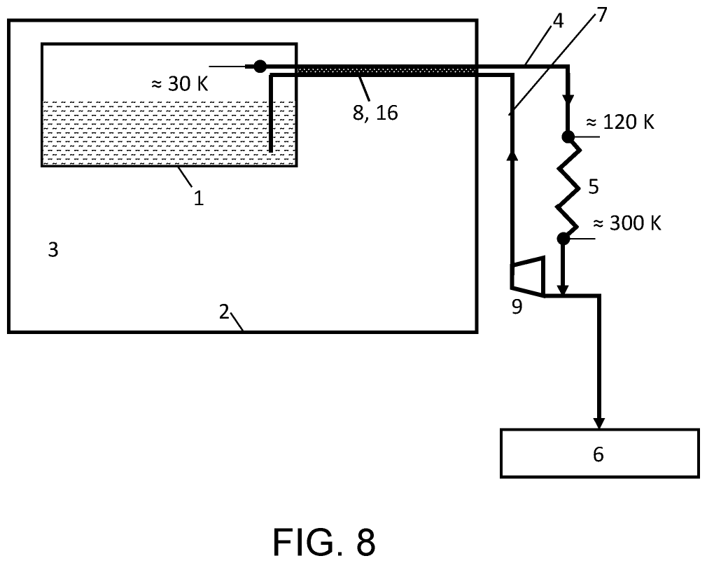

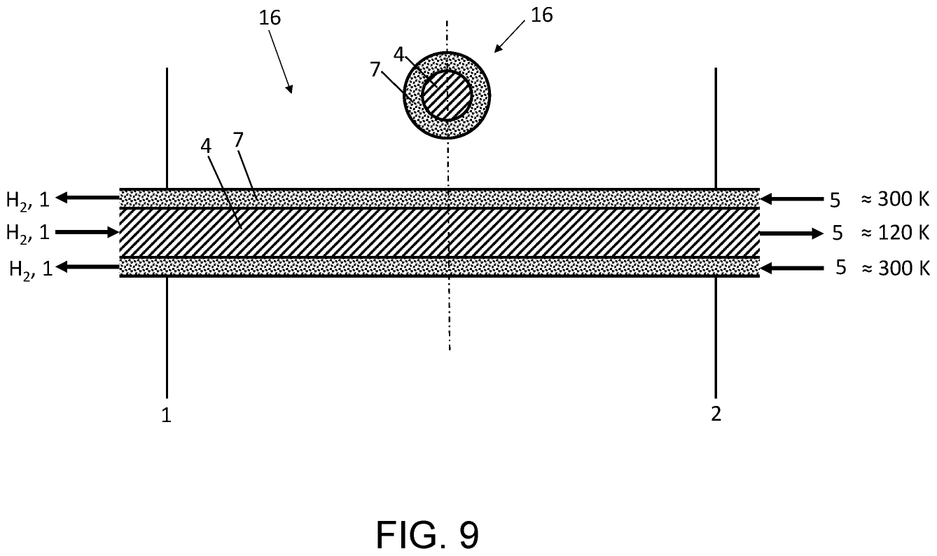

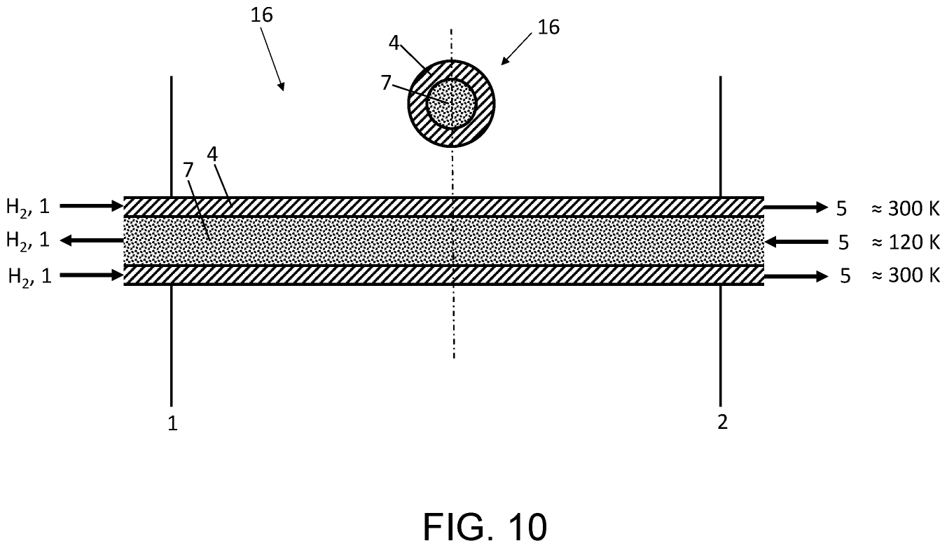

In a further advantageous embodiment of a cryotank in accordance with one or more embodiments, both the inner-tank heat exchanger 10 and the second heat exchanger 12 may be omitted. In this case, a blower 9 is used which delivers a part of the cryogas after it has been warmed back into the inner tank 1. There, it then releases its heat to the liquid cryogas and evaporates the latter. Previously, the warm cryogas travels past the evaporated emerging cold cryogas in counter-current flow. A tube arrangement 16 for such a thermal contact 8 of FIG. 8 is represented in FIG. 9 and a further possible embodiment is represented in FIG. 10.

In this “open system,” the “thermal contact” 8 takes place merely by a coaxial arrangement of two pipelines. FIG. 8 illustrates this. The configuration of the insulation vacuum 3 and of the MLI 17 may be carried out as shown in FIGS. 6 and 7. The evaporated gaseous hydrogen (H2) is conveyed via the extraction line 4 to the first heat exchanger 5 and is recirculated further from the latter via the recirculation line 7 into the liquid hydrogen. The extraction line 4 may in this case be arranged radially inwards (FIG. 9) or radially outwards (FIG. 10) with respect to the recirculation line 7.

An extraction method for a cryotank may comprise the steps of the cryogas flow extracted from the inner tank 1 being routed via an extraction line 4 and warmed in a first heat exchanger 5, and a partial gas flow branched off therefrom being delivered via a blower 9 and a recirculation line 7 back to the inner tank 1, the gas flow coming from the inner tank 1 and the gas flow conveyed to the inner tank 1 being in thermal contact and heat transfer taking place between the two fluid flows.

Overall, the invention therefore shows that a good thermal contact 8 may be set up between an evaporated cryogas flow and a partial gas flow recirculated from a first heat exchanger 5 to the inner tank 1. The recirculated partial gas flow coming from the first heat exchanger 5 and flowing to the inner tank 1 may be mixed in the latter with the cold cryogas. The heat transfer between the evaporated partial gas flow coming from the inner tank 1 and recirculated, leading to the inner tank 1 may be made possible by a coaxial arrangement of two tubes.

The recirculated partial gas flow coming from the first heat exchanger 5 and flowing to the inner tank 1 may be routed via an inner-tank heat exchanger 10 and subsequently routed out from the inner tank 1 to a second heat exchanger 12, and combined with the main gas flow downstream of a control valve 15 that throttles the main gas flow, there being a good thermal contact between the evaporated cryogas flow and the partial gas flow recirculated from the inner-tank heat exchanger 10 to the second heat exchanger 12.

The heat transfer between the evaporated cryogas flow and the partial gas flow coming from the inner tank 1 and routed to the inner tank 1 may be made possible by a coaxial arrangement of three tubes.

The insulation vacuum around the coaxial tube arrangement 16 may be incorporated into the region of the inner tank 1. The coaxial tube arrangement 16 may have an inclination relative to the horizontal.

The coaxial tube arrangement 16 may be enclosed by a superinsulation.

The cryogas flow extracted from the inner tank 1 may be routed via a line and warmed in a first heat exchanger 5, and a partial gas flow branched off therefrom may be delivered via a blower 9 and a line back to the inner tank 1, the gas flow coming from the inner tank 1 and the gas flow conveyed to the inner tank 1 being in thermal contact 8 and heat transfer taking place between the two fluid flows.

The cryogas flow extracted from the inner tank 1 may be routed via a line and warmed in a first heat exchanger 5, and a partial gas flow branched off therefrom may be delivered via a line back to the inner tank 1, and the partial gas flow conveyed to the inner tank 1 may pass through an inner-tank heat exchanger 10, subsequently be routed via a line to a second heat exchanger 12 and combined with the main flow downstream of a control valve 15 that throttles the main gas flow, the evaporated cryogas flow coming from the inner tank 1 and routed to the first heat exchanger 5 being in thermal contact 8 with the partial gas flow supplied to the inner tank 1 and discharged therefrom, and heat transfer taking place between the three fluid flows.

### LIST OF REFERENCE SYMBOLS

1, 101 inner tank
2, 102 outer container
3, 103 insulation space
4, 104 extraction line
5, 105 first heat exchanger
6, 106 consumer
7, 107 recirculation line
8 thermal contact
9 blower
10, 110 inner-tank heat exchanger
11, 111 secondary recirculation line section of the recirculation line
12, 112 second heat exchanger
13, 113 valve
14, 114 throttle
15 control valve
16 tube arrangement
17 multi-layer insulation (MLI)

What is claimed is:

1. A cryotank, comprising:
an inner tank for receiving a medium stored in the cryotank;
an outer container enclosing the inner tank;
an insulation space arranged between the inner tank and the outer container;
a first heat exchanger arranged outside the inner tank and the outer container;
an extraction device for the medium, the extraction device having at least one extraction line arranged in the insulation space to facilitate conveying of the medium out of the inner tank to the first heat exchanger; and
a recirculation line back arranged in the insulation space in thermal contact with the at least one extraction line to facilitate conveying a recirculation partial flow back into the inner tank and an extraction partial flow downstream of the first heat exchanger to a consumer.

2. The cryotank of claim 1, wherein:
the at least one extraction line comprises an extraction line tube having an extraction line tube wall section,
the recirculation line comprises a recirculation line tube having a recirculation line tube wall section thermally connected to the extraction line tube wall section in the insulation space, and
the extraction line tube wall section and the recirculation line tube wall section are common to each other at least in sections through the insulation space and at least along a sector of their respective circumferences.

3. The cryotank of claim 1,
the at least one extraction line comprises an extraction line tube having an extraction line coaxial tube section arranged in the insulation space,
the recirculation line comprises a recirculation line tube having a recirculation line coaxial tube section arranged in the insulation space for thermal connection with the extraction line coaxial tube section, and
the extraction line being routed on an outside thereof and the recirculation line being routed on an inside thereof.

4. The cryotank of claim 1, further comprising a blower to deliver the recirculation partial flow of the medium through the recirculation line back into the inner tank.

5. The cryotank of claim 1, further comprising:
a second heat exchanger arranged outside the inner tank, and
an inner-tank heat exchanger, arranged in the inner tank, through which the recirculation partial flow of the medium is conveyed via the recirculation line back into the inner tank, the medium being conveyed downstream of the inner-tank heat exchanger via a secondary recirculation line section of the recirculation line to the second heat exchanger.

6. The cryotank of claim 5, wherein the second heat exchanger is arranged outside the outer container.

7. The cryotank of claim 5, wherein the at least one extraction line and a secondary recirculation line section of the recirculation line are arranged in the insulation space to establish thermal contact between the at least one extraction line and the secondary recirculation line section of the recirculation line.

8. The cryotank of claim 5, wherein:
the at least one extraction line comprises an extraction line coaxial tube arranged in the insulation space,
the recirculation line comprises a recirculation line coaxial tube arranged in the insulation space for thermal connection with the extraction line coaxial tube, and
the secondary recirculation line section comprises a secondary recirculation line section coaxial tube arranged in the insulation space for thermal connection with the extraction line coaxial tube and the recirculation line coaxial tube.

9. The cryotank of claim 8, wherein the at least one extraction line forms a central tube embedded between the recirculation line and the secondary recirculation line section.

10. The cryotank of claim 1, further comprising an elongated installation space extending in the insulation space of the inner tank to receive the at least one extraction line and the recirculation line.

11. The cryotank of claim 10, wherein the elongated installation space extends horizontally in the insulation space of the inner tank.

12. The cryotank of claim 10, wherein the elongated installation space extends obliquely in the insulation space of the inner tank.

13. A cryotank, comprising:
an inner tank for receiving a medium stored in the cryotank;
an outer container enclosing the inner tank;
an insulation space arranged between the inner tank and the outer container;
a first heat exchanger arranged outside the inner tank and the outer container;
an extraction device for the medium, the extraction device having at least one extraction line arranged in the insulation space to facilitate conveying of the medium out of the inner tank to the first heat exchanger;
a recirculation line back arranged in the insulation space in thermal contact with the at least one extraction line to facilitate conveying a recirculation partial flow back into the inner tank and an extraction partial flow downstream of the first heat exchanger to a consumer;
a second heat exchanger arranged outside the inner tank, and
an inner-tank heat exchanger, arranged in the inner tank, through which the recirculation partial flow of the medium is conveyed via the recirculation line back into the inner tank, the medium being conveyed downstream of the inner-tank heat exchanger via a secondary recirculation line section of the recirculation line to the second heat exchanger.

14. The cryotank of claim 13, wherein:
the at least one extraction line comprises an extraction line tube having an extraction line tube wall section,
the recirculation line comprises a recirculation line tube having a recirculation line tube wall section thermally connected to the extraction line tube wall section in the insulation space, and
the extraction line tube wall section and the recirculation line tube wall section are common to each other at least in sections through the insulation space and at least along a sector of their respective circumferences.

15. The cryotank of claim 13,
the at least one extraction line comprises an extraction line tube having an extraction line coaxial tube section arranged in the insulation space,
the recirculation line comprises a recirculation line tube having a recirculation line coaxial tube section arranged in the insulation space for thermal connection with the extraction line coaxial tube section, and
the extraction line being routed on an outside thereof and the recirculation line being routed on an inside thereof.

16. The cryotank of claim 13, further comprising a blower to deliver the recirculation partial flow of the medium through the recirculation line back into the inner tank.

17. The cryotank of claim 13, wherein the second heat exchanger is arranged outside the outer container.

18. The cryotank of claim 13, wherein the at least one extraction line and a secondary recirculation line section of the recirculation line are arranged in the insulation space to establish thermal contact between the at least one extraction line and the secondary recirculation line section of the recirculation line.

19. The cryotank of claim 13, wherein:
the at least one extraction line comprises an extraction line coaxial tube arranged in the insulation space,
the recirculation line comprises a recirculation line coaxial tube arranged in the insulation space for thermal connection with the extraction line coaxial tube, and
the secondary recirculation line section comprises a secondary recirculation line section coaxial tube arranged in the insulation space for thermal connection with the extraction line coaxial tube and the recirculation line coaxial tube.

20. The cryotank of claim 13, further comprising an elongated installation space extending in the insulation space of the inner tank to receive the at least one extraction line and the recirculation line.
